(19) United States
(12) Patent Application Publication
(10) Pub. No.: US 2008/0104266 A1
(43) Pub. Date: May 1, 2008

(54) Reliable messaging using message streams in a high speed, low latency data communications environment

(76) Inventors: Eliezer Dekel, Haifa (IL); John J. Duigenan, Haifa (IL); Gidon Gershinsky, Haifa (IL); Avraham Harpaz, Haifa (IL); Nir Naaman, Haifa (IL); Foluso O. Okunseinde, Austin, TX (US); Hilary A. Pike, College Station, TX (US); Yoav Tock, Nesher (IL); Cornell G. Weight, Austin, TX (US)

Correspondence Address: INTERNATIONAL CORP (BLF), c/o BIGGERS & OHANIAN, LLP, P.O. BOX 1469, AUSTIN, TX, 78767-1469, US

(21) Appl. No.: 11/586,076

(22) Filed: Oct. 25, 2006

(51) Int. Cl. G06F 15/16

(52) U.S. Cl. 709/231; 709/237; 709/227

(57) ABSTRACT

Methods, apparatus, and products are disclosed for reliable messaging using message streams in a high speed, low latency data communications environment that include: receiving, in a transport engine of a message receiving device from an active message sending device, active transport packets on an active message stream established from the active message sending device to the message receiving device, the active message sending device encapsulating active application messages in the active transport packets; identifying, by the transport engine, a missing active application message from the active message sending device; and requesting, by the transport engine from a backup message sending device, transmission of a backup application message that corresponds to the missing active application message, the backup message sending device encapsulating backup application messages in backup transport packets for transmission on a backup message stream, each backup application message representing a duplicate of a corresponding active application message.

### BACKGROUND OF THE INVENTION

1. Field of the Invention

The field of the invention is data processing, or, more specifically, methods, apparatus, and products for reliable messaging using message streams in a high speed, low latency data communications environment.

2. Description of Related Art

Messaging environments are generally available to provide data communication between message sending devices and message receiving devices using application messages. An application message is a quantity of data that includes one or more data fields and is passed from a message producer installed on a message sending device to a message consumer installed on a message receiving device. An application message is a form of message recognized by application software operating in the application layer of a data communication protocol stack—as contrasted for example with a transport message or network message which are forms of messages recognized in the transport layer and the network layer respectively. An application message may represent, for example, numeric or textual information, images, encrypted information, and computer program instructions.

A messaging environment may support point-to-point messaging, publish and subscribe messaging, or both. In a point-to-point messaging environment, a message producer may address an application message to a single message consumer. In a publish and subscribe messaging environment, a message producer may publish an application message to a particular channel or topic and any message consumer that subscribes to that channel or topic receives the message. Because message producers and message consumers communicate indirectly with each other via a channel or topic in a publish and subscribe environment, message transmission is decoupled from message reception. As a consequence, neither producers nor consumers need to maintain state about each other, and dependencies between the interacting participants are reduced or eliminated. A publish and subscribe environment may, therefore, allow message publishers and message subscribers to operate asynchronously.

For further explanation of a messaging environment, FIG. 1 sets forth a block diagram illustrating a typical messaging environment for data communications that includes a message sending device (100), a message receiving device (104), and a message administration server (102). The message sending device (100) is a computer device having installed upon it a message producer (110), a set of computer program instructions configured for transmitting application messages to the message administration server (102) for delivery to a message receiving device. In the example of FIG. 1, the message producer (110) transmits application messages to the message administration server (102) on a message stream (106). The message sending device (100) may produce the transmitted messages by generating the application messages from data of the message sending device itself or data received from some other source. The message receiving device (104) is a computer device having installed upon it a message consumer (112), a set of computer program instructions configured for receiving application messages from the message administration server (102). In the example of FIG. 1, the message consumer (112) receives the application messages from the message administration server (102) on a message stream (108). In the example of FIG. 1, the message stream (106) and the message stream (108) are data communication channels implemented using, for example, the User Datagram Protocol (‘UDP’) and the Internet Protocol (‘IP’).

In either a point-to-point messaging environment or a publish and subscribe messaging environment, the application messages transmitted from message sending devices to message receiving devices typically pass through the message administration server (102). The message administration server (102) is computer device having installed upon it a message administration module (114), computer program instructions configured for administering the messages transmitted from the message producer (110) to the message consumer (112). Examples of message administration modules may include the IBM WebSphere® MQ, the Open Message Queue from Sun Microsystems, and the OpenJMS from The OpenJMS Group. In a point-to-point messaging environment, the message administration module (114) provides message queuing for the message consumer (112) as the message administration module (114) receives application messages addressed to the consumer (112) from various message providers. In a publish and subscribe messaging environment, the message administration module (114) administers the various channels or topics to which message producers publish and message consumers subscribe. In either message environment, the message administration module (114) may also provide security services to ensure that the only messages arriving at the messaging consumer (112) from the message producer (110) are those messages that the message consumer (112) is authorized to receive and that the message producer (110) is authorized to send. Moreover, the message administration module (114) may also coordinate providing to the message consumer backup messages from a backup message producer in the event that a failure occurs on the message producer (110).

Current messaging environments such as, for example, the one described above with reference to FIG. 1, have certain drawbacks. Application messages transmitted to a message administration server from a message sending device for delivery to a message receiving device are delayed in the message administration server until the message administration server can process the messages. The message processing that occurs in the message administration server increases the overall messaging latency of the messaging environment and decreases the overall speed for transmitting data in the data communications environment. Messaging latency is the time period beginning when the message producer transmits an application message and ending when the message consumer receives the application message.

In many data communication environments, even slight increases in messaging latency are costly. Consider, for example, a financial market data environment. A financial market data environment is a data processing environment used to communicate information about financial markets and participants in financial markets. In a financial market data environment, an application message is commonly referred to as a ‘tick’ and represents financial market data such as, for example, financial quotes or financial news. Financial quotes include bid and ask prices for any given financial security. A ‘bid’ refers to the highest price a buyer is willing to pay for a security. An ‘ask’ refers to the lowest price a seller is willing to accept for a security. In a financial market data environment, a message producer may provide quotes for the purchase or sale of financial securities based on real-time financial market conditions, and a message consumer may buy and sell financial securities based on financial quotes. When a message consumer buys or sells a financial security based on the quoted price provided by the message producer, the ability of a message consumer to obtain the bid or ask in the quote for the financial security is largely influenced by messaging latency in the financial market data environment. The higher the messaging latency, the less likely a buy or sell order generated by the message consumer will execute at or near the price stated in the financial quote. In fact, a highly volatile security may fluctuate in price dramatically over a time period of a few seconds.

Current solutions to reduce messaging latency are to remove the message administration server from the messaging environment. In such current solutions, the message sending devices send application messages directly to message receiving devices. The drawback to such current solutions is that removing the message administration server removes the administration functionality provided by the message administration server from the messaging environment. Current solutions, therefore, effectively offer no solution in messaging environments where the administrative functions of a message administration server are required. Consider again the financial market data environment example from above. In such an exemplary financial market data environment, consider that a message receiving device is only authorized to receive financial quotes on certain financial securities or only authorized to receive financial quotes that are at least fifteen minutes old. Removing the message administration server from such a financial market data environment removes the ability to administer the messages received by the message receiving device from the message sending device in the financial market data environment.

An additional drawback to current messaging environments, such as, for example, the one describe above with reference to FIG. 1, involves the message administration server obtaining a missed application message sent from a message sending device. When the message sending device transmits messages to the message administration server, the message sending device typically encapsulates the application messages into transport packets. During transmission of the packets, the message administration server will often miss a number of messages during the time period of encompassing the transmissions. In response, the message administration server sends a negative acknowledgement (‘NAK’) to the active message sending device indicating that the message administration server did not receive a particular packet containing the missed application messages. When the message sending device receives the NAK from the message administration server, the message sending device identifies the missing packet and retransmits the missing packet to the message administration server. Identifying the missing packet and retransmitting the missing packet to the message administration server, however, increases the processing load on the message sending device. When a message sending device has to process a large number of retransmission requests, the performance and utility of such a message sending device often decreases dramatically. As such, there is a vast need for improvement in how current messaging environments reliably handle retransmission requests.

### SUMMARY OF THE INVENTION

Methods, apparatus, and products are disclosed for reliable messaging using message streams in a high speed, low latency data communications environment that include: receiving, in a transport engine of a message receiving device from an active message sending device, active transport packets on an active message stream established from the active message sending device to the message receiving device, the active message sending device encapsulating active application messages in the active transport packets, each active transport packet including one or more active application messages; identifying, by the transport engine, a missing active application message from the active message sending device; and requesting, by the transport engine from a backup message sending device that becomes active upon failover from the active message sending device, transmission of a backup application message that corresponds to the missing active application message, the backup message sending device encapsulating backup application messages in backup transport packets for transmission on a backup message stream established from the backup message sending device to the message receiving device, each backup transport packet including one or more backup application messages, each backup application message representing a duplicate of a corresponding active application message.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 sets forth a block diagram illustrating a typical messaging environment for data communications.

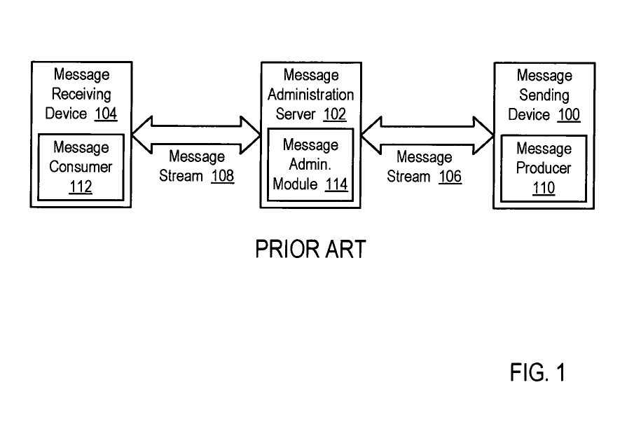

FIG. 2 sets forth a network and block diagram illustrating an exemplary computer data processing system for reliable messaging using message streams in a high speed, low latency data communications environment according to exemplary embodiments of the present invention.

FIG. 3 sets forth a block diagram of automated computing machinery comprising an exemplary message receiving device useful in providing reliable messaging using message streams in a high speed, low latency data communications environment according to exemplary embodiments of the present invention.

FIG. 4 sets forth a flowchart illustrating an exemplary method for reliable messaging using message streams in a high speed, low latency data communications environment according to exemplary embodiments of the present invention.

FIG. 5 sets forth a flowchart illustrating a further exemplary method for reliable messaging using message streams in a high speed, low latency data communications environment according to exemplary embodiments of the present invention.

FIG. 6 sets forth a flowchart illustrating a further exemplary method for reliable messaging using message streams in a high speed, low latency data communications environment according to exemplary embodiments of the present invention.

### DETAILED DESCRIPTION OF EXEMPLARY EMBODIMENTS

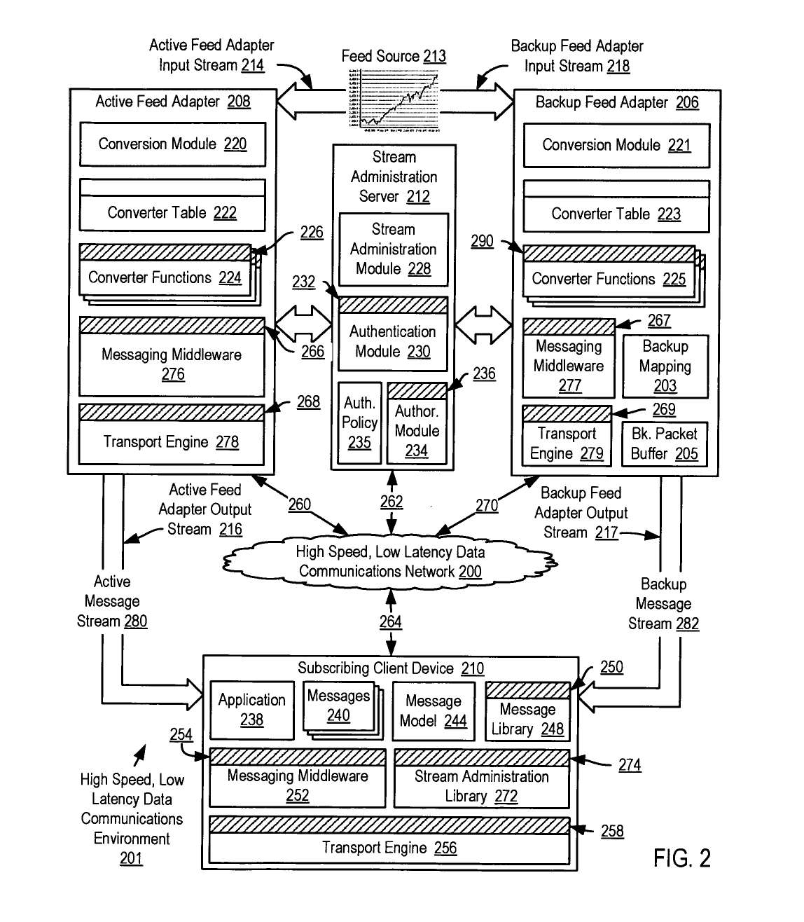

Exemplary methods, apparatus, and products for reliable messaging using message streams in a high speed, low latency data communications environment according to embodiments of the present invention are described with reference to the accompanying drawings, beginning with FIG. 2. FIG. 2 sets forth a network and block diagram illustrating an exemplary computer data processing system for reliable messaging using message streams in a high speed, low latency data communications environment (201) according to embodiments of the present invention. The system of FIG. 2 operates generally for reliable messaging using message streams in a high speed, low latency data communications environment according to embodiments of the present invention as follows: A transport engine (256) of a message receiving device receives active transport packets on an active message stream (280) from an active message sending device, the active message stream (280) established from the active message sending device to the message receiving device. In the example of FIG. 2, the active message sending device is implemented as an active feed adapter (208), and the message receiving device is implemented as a subscribing client device (210).

A stream administration server (212) of FIG. 2 brokers the establishment of the active message stream (280) from the active message sending device (208) to the message receiving device (210). The active message sending device (208) encapsulates active application messages in the active transport packets. Each active transport packet includes one or more active application messages. Readers will note that in this specification a transport packet that includes one application message may refer to a transport packet that includes an entire application message or a fragment of an application message.

In the example of FIG. 2, the transport engine (256) identifies a missing active application message from the active message sending device (208). The transport engine (256) also requests transmission of a backup application message that corresponds to the missing active application message from a backup message sending device that becomes active upon failover from the active message sending device (208). Failover is the process of transitioning from a failed active component to a redundant backup component. In the example of FIG. 2, the backup message sending device is implemented as a backup feed adapter (206). The backup message sending device (206) encapsulates backup application messages in backup transport packets for transmission on a backup message stream (282) established from the backup message sending device (206) to the message receiving device (210). In the example of FIG. 2, the stream administration server (212) also brokers the establishment of a backup message stream (282) from the backup message sending device (206) to the message receiving device (210). Each backup transport packet includes one or more backup application messages, and each backup application message represents a duplicate of a corresponding active application message.

The high speed, low latency data communications environment (201) illustrated in FIG. 2 includes a high speed, low latency data communications network (200). The network (200) includes an active feed adapter (208), a backup feed adapter (206) a stream administration server (212), and a subscribing client device (210), as well as the infrastructure for connecting such devices (206, 208, 212, 210) together for data communications. The network (200) of FIG. 2 is termed ‘high speed, low latency’ because the application messages sent between devices connected to the network (200) on message streams administered by the stream administration server (212) bypass the stream administration server (212). For example, the application messages on the active message stream (280) from the active feed adapter (208) to the subscribing client device (210) bypass the stream administration server (212). Similarly, the application messages on the backup message stream (282) from the backup feed adapter (206) to the subscribing client device (210) bypass the stream administration server (212). Although such messages are not delayed for processing in the stream administration server (212), the stream administration server (212) retains administration of the streams (280, 282) between devices connected to the high speed, low latency data communications network (200).

Further contributing to the ‘high speed, low latency’ nature of network (200), readers will note that the network (200) does not include a router, that is a computer networking device whose primary function is to forward data packets across a network toward their destinations. Rather, each device (206, 208, 212, 210) provides its own routing functionality for data communication through a direct connection with the other devices connected to the network (200). Because the network (200) does not include a computer networking device dedicated to routing data packets, the network (200) of FIG. 2 may be referred to as a ‘minimally routed network.’ Although the exemplary network (200) illustrated in FIG. 2 does not include a router, such a minimally routed network is for explanation only. In fact, some high speed, low latency networks useful in reliable messaging using message streams in a high speed, low latency data communications environment according to embodiments of the present invention may include a router.

As mentioned above, the high speed, low latency data communications environment (201) depicted in FIG. 2 includes two message streams (280, 282). A message stream is a data communication channel between a communications endpoint of a sending device and a communications endpoint of at least one receiving device. A communications endpoint is composed of a network address and a port for a sending device or a receiving device. A message stream may be implemented as a multicast data communication channel. In a multicast data communication channel, a one-to-many relationship exists between a destination address for a message and the communication endpoints of receiving devices. That is, each destination address identifies a set of communication endpoints for receiving devices to which each message of the stream is replicated. A multicast data communication channel may be implemented using, for example, the User Datagram Protocol (‘UDP’) and the Internet Protocol (‘IP’). In addition to a multicast data communication channel, the message stream may be implemented as a unicast data communication channel. In a unicast data communication channel, a one-to-one relationship exists between a destination address for a message and a communication endpoint of a receiving device. That is, each destination address uniquely identifies a single communication endpoint of single receiving device. A unicast data communication channel may be implemented using, for example, the Transmission Control Protocol (‘TCP’) and IP.

The exemplary system of FIG. 2 includes a stream administration server (212) connected to the high speed, low latency data communications network (200) through a wireline connection (262). The stream administration server (212) of FIG. 2 is a computer device having installed upon it a stream administration module (228), an authentication module (230), an authorization module (234), and an authorization policy (235). A stream administration module (228) is a set of computer program instructions configured for reliable messaging using message streams in a high speed, low latency data communications environment according to embodiments of the present invention. The stream administration module (228) operates generally for reliable messaging using message streams in a high speed, low latency data communications environment according to embodiments of the present invention by brokering establishment of the active message stream (280) from the active message sending device (208) to the message receiving device (210) and brokering establishment of a backup message stream (282) from the backup message sending device (206) to the message receiving device (210). In addition, the stream administration module (228) administers the message streams by providing security services such as authenticating the subscribing client device (210) and authorizing the subscribing client device (210) to receives application messages from the feed adapters (206, 208) on the message streams (280, 282).

The authentication module (230) of FIG. 2 is a set of computer program instructions capable of providing authentication security services to the stream administration module (228) through an exposed authentication application programming interface (‘API’) (232). Authentication is a process verifying the identity of an entity. In the exemplary system of FIG. 2, the authentication module (230) verifies the identity of the subscribing client device (210). The authentication module (230) may provide authentication security services using a variety of security infrastructures such as, for example, shared-secret key infrastructure or a public key infrastructure.

The authorization module (234) of FIG. 2 is a set of computer program instructions capable of providing authorization security services to the stream administration module (228) through an exposed authorization API (236). Authorization is a process of only allowing resources to be used by resource consumers that have been granted authority to use the resources. In the example of FIG. 2, the authorization module (234) identifies the application messages that the subscribing client device (210) is authorized to receive on the message streams (280, 282). The authorization module (234) of FIG. 2 provides authorization security services using an authorization policy (235). The authorization policy (235) is a set of rules governing the privileges of authenticated entities to send or receive application messages on a message stream. In a financial market data environment, for example, an authenticated entity may be authorized to receive application messages that include financial quotes for some financial securities but not other securities. The authorization policy (235) may grant privileges on the basis of an individual entity or an entity's membership in a group.

In the exemplary system of FIG. 2, active feed adapter (208) is connected to the high speed, low latency data communications network (200) through a wireline connection (260). The active feed adapter (208) is a computer device having the capabilities of converting application messages on a active feed adapter input stream (214) having a first format to application messages on a active feed adapter output stream (216) having a second format and transmitting the application messages on the active feed adapter output stream (216) to subscribing client devices. The active feed adapter input stream (214) is a message stream from a feed source to the active feed adapter (208). The active feed adapter output stream (216) is a message stream administered by the stream administration server (212) from the active feed adapter (208) to the subscribing client device (210).

In the example of FIG. 2, the active feed adapter (208) receives application messages on the active feed adapter input stream (214) from a feed source (213). The feed source (213) is a computer device capable of aggregating data into application messages and transmitting the messages to a feed adapter. In a financial market data environment, for example, a feed source (213) may be implemented as a feed source controlled by the Options Price Reporting Authority (‘OPRA’). OPRA is the securities information processor for financial market information generated by the trading of securities options in the United States. The core information that OPRA disseminates is last sale reports and quotations. Other examples of feed sources in financial market data environment may include feed sources controlled by the Consolidated Tape Association (‘CTA’) or The Nasdaq Stock Market, Inc. The CTA oversees the dissemination of real-time trade and quote information in New York Stock Exchange and American Stock Exchange listed securities. The Nasdaq Stock Market, Inc. operates the NASDAQ Market Center^{SM} which is an electronic screen-based equity securities market in the United States. In a financial market data environment, a feed adapter input stream is referred to as a ‘financial market data feed.’

The active feed adapter (208) of FIG. 2 has installed upon it a conversion module (220), a converter table (222), converter functions (224), messaging middleware (276), and a transport engine (278). The conversion module (220) is a set of computer program instructions for converting application messages received on the active feed adapter input stream (214) having a first format into application messages having a second format for transmission to subscribing devices on the active feed adapter output stream (216). The conversion module (220) converts application messages from the first format to the second format according to the converter table (222).

The converter table (222) of FIG. 2 is a table that specifies the converter functions (224) capable of converting the application message from one format to another format. Utilizing multiple converter tables, the conversion module (220) may convert messages from a variety of input formats to a variety of output formats. In the example of FIG. 2, the converter table (222) specifies the converter functions (224) capable of converting the application message received from the active feed adapter input stream (214) having the first format to application messages having the second format for transmission to subscribing client devices on the active feed adapter output stream (216). The converter table (222) of FIG. 2 may be implemented using a structured document such as, for example, an eXtensible Markup Language (‘XML’) document.

The converter functions (224) of FIG. 2 are functions capable of converting data fields in an application message from one format to another format or converting values of data fields from one value to another value. Converter functions (224) may, for example, convert a 16-bit integer to a 32-bit integer, convert a number stored in a string field to a 64-bit double floating point value, increase the value of one data field by one, or any other conversion as will occur to those of skill in the art. The conversion module (220) accesses the converter functions (224) through a set of converter function APIs (226) exposed by the converter functions (224).

Before the conversion module (220) of FIG. 2 performs data processing on the application messages, the conversion module (220) receives the messages from the feed source (213). The conversion module (220) of FIG. 2 may receive the source stream messages through a receiving transport engine (not shown) of the active feed adapter (208). The receiving transport engine is a software module that operates in the transport layer of the network stack and may be implemented according to the TCP/IP protocols, UDP/IP protocols, or any other data communication protocol as will occur to those of skill in the art. The receiving transport engine may provide the received application messages directly to the conversion module (220) or to the messaging middleware (276), which in turn, provides the source stream messages to the conversion module (220).

The messaging middleware (276) of FIG. 2 is a software component that provides high availability services between the active feed adapter (208), the backup feed adapter (206), the subscribing client device (210), and the feed source (213). After the conversion module (220) of FIG. 2 performs data processing on the application messages received from the feed source (213), the messaging middleware (276) receives the application messages from the conversion module (220) and provides the received application messages to the transport engine (278) for transmission to a subscribing client device on the active feed adapter output stream (216). The conversion module (220) interacts with the messaging middleware (276) through a messaging middleware API (266) exposed by the messaging middleware (276).

The transport engine (278) of FIG. 2 is a software component operating in the transport and network layers of the OSI protocol stack promulgated by the International Organization for Standardization. The transport engine (278) provides data communications services between network-connected devices. The transport engine may be implemented according to the UDP/IP protocols, TCP/IP protocols, or any other data communications protocols as will occur to those of skill in the art. The transport engine (278) includes a set of computer program instructions capable of encapsulating the application messages provided by the messaging middleware (276) into packets and transmitting the packets through the active message stream (280) to the subscribing client device (210). The messaging middleware (276) operates the transport engine (278) through a transport API (268) exposed by the transport engine (278).

In the exemplary system of FIG. 2, backup feed adapter (206) is connected to the high speed, low latency data communications network (200) through a wireline connection (270). The backup feed adapter (206) is a computer device having the capabilities of converting backup messages on a backup feed adapter input stream (218) having a first format to backup messages on a backup feed adapter output stream (217) having a second format and transmitting the backup messages on the backup feed adapter output stream (217) to subscribing client devices. The backup feed adapter input stream (218) is a message stream from the feed source (213) to the backup feed adapter (206). The backup feed adapter output stream (217) is a message stream administered by the stream administration server (212) from the backup feed adapter (206) to the subscribing client device (210).

The backup feed adapter (206) of FIG. 2 has installed upon it a conversion module (221), a converter table (223), converter functions (225) that expose converter function APIs (290), messaging middleware (277) that exposes messaging middleware API (267), a transport engine (279) that exposes a transport engine API (269), a backup packet buffer (205), and a backup mapping (203) of the backup application messages to the active transport packets. The components installed on the backup feed adapter (206) operate in a manner similar to the components installed on the active feed adapter (208).

In addition to the transport services mentioned above, the transport engine (279) of the backup feed adapter (206) also operates generally for reliable messaging using message streams in a high speed, low latency data communications environment according to embodiments of the present invention. The transport engine (279) operates for reliable messaging using message streams in a high speed, low latency data communications environment according to embodiments of the present invention by transmitting, to the transport engine (256) on the backup message stream (282), a backup transport packet that includes the backup application message corresponding to the missing backup application message. The transport engine (279) also operates for reliable messaging using message streams in a high speed, low latency data communications environment according to embodiments of the present invention by: maintaining a backup mapping (203) of the backup application messages to the backup transport packets; identifying, in dependence upon the backup mapping (203), a backup transport packet that includes the backup application message specified in the message transmission request; and transmitting the identified backup transport packet to the transport engine (256). The backup mapping (203) of the backup application messages to the backup transport packets is a map of the particular backup application messages that the backup message sending device encapsulated into each backup transport packet. When the message receiving device specifies a backup transport packet in a message transmission request, the transport engine (279) also operates for reliable messaging using message streams in a high speed, low latency data communications environment according to embodiments of the present invention by transmitting the backup transport packet specified in the message transmission request to the transport engine (256).

The subscribing client device (210) in exemplary system of FIG. 2 connects to the high speed, low latency data communications network (200) through a wireline connection (264). The subscribing client device (210) of FIG. 2 is a computer device capable of subscribing to the message streams transmitted by various feed adapters. In a financial market data environment, for example, a subscribing client device may subscribe to a tick to receive the bid and ask prices for a particular security on a message stream provided by a feed adapter controlled by a financial securities broker.

In the example of FIG. 2, the subscribing client device (210) has installed upon it an application (238), a message library (248), messaging middleware (252), a stream administration library (272), and a transport engine (256). The application (238) is a software component that processes data contained in the application messages (240) received from one of the feed adapters (208, 206). The application (238) may process the data for utilization by the subscribing client device (210) itself, for contributing the data to another feed adapter, or for contributing the data to some other device. In a financial market data environment, the application installed on the subscribing client device may be a program trading application that buys or sells financial securities based on the quoted prices contained in ticks. The application may also be a value-adding application that contributes information to a tick such as, for example, the best bid and ask prices for a particular security, that is not typically included in the ticks provided by the feed source (213). The subscribing client device may then transmit the ticks to a feed adapter for resale to other subscribing client devices.

In the example of FIG. 2, the application messages (240) have a format specified in a message model (244). The message model (244) is metadata that defines the structure and the format of the application messages (240) received on the message streams (280, 282). The message model (244) may be attached to and transmitted along with the application messages (240) received from the feed adapters (208, 206). More often, however, both the subscribing client device (210) and the feed adapters (208, 206) may receive the message model (244) from the stream administration server (212) when the stream administration server (212) brokers the message streams (280, 282). A message model may be implemented using a structured document, such as, for example, an XML document, a Java object, C++ object, or any other implementation as will occur to those of skill in the art.

The application (238) processes the data contained in the application messages (240) using the message library (248). The message library (248) is a set of functions that are computer program instructions for creating, accessing, and manipulating messages (240) according to a message model (244). The message library (248) is accessible to the application (238) through a message API (250) exposed by the message library (248).

The communications between the subscribing client device (210) and the stream administration server (212) may be implemented using a stream administration library (272). The stream administration library (272) is a set of functions contained in dynamically linked libraries or statically linked libraries available to the application (238) through a stream administration library API (274). Through the stream administration library (272), the application (238) of the subscribing client device (210) may request to subscribe to messages from a feed adapter, modify an existing message subscription, or cancel a subscription. Functions of the stream administration library (272) used by the application (238) may communicate with the stream administration server (212) through network (200) by calling member methods of a CORBA object, calling member methods of remote objects using the Java Remote Method Invocation (‘RMI’) API, using web services, or any other communication implementation as will occur to those of skill in the art.

‘CORBA’ refers to the Common Object Request Broker Architecture, a computer industry specifications for interoperable enterprise applications produced by the Object Management Group (‘OMG’). CORBA is a standard for remote procedure invocation first published by the OMG in 1991. CORBA can be considered a kind of object-oriented way of making remote procedure calls, although CORBA supports features that do not exist in conventional RPC. CORBA uses a declarative language, the Interface Definition Language (“IDL”), to describe an object's interface. Interface descriptions in IDL are compiled to generate ‘stubs’ for the client side and ‘skeletons’ on the server side. Using this generated code, remote method invocations effected in object-oriented programming languages, such as C++ or Java, look like invocations of local member methods in local objects.

The Java™ Remote Method Invocation API is a Java application programming interface for performing remote procedural calls published by Sun Microsystems™. The Java™ RMI API is an object-oriented way of making remote procedure calls between Java objects existing in separate Java™ Virtual Machines that typically run on separate computers. The Java™ RMI API uses a remote procedure object interface to describe remote objects that reside on the server. Remote procedure object interfaces are published in an RMI registry where Java clients can obtain a reference to the remote interface of a remote Java object. Using compiled ‘stubs’ for the client side and ‘skeletons’ on the server side to provide the network connection operations, the Java™ RMI allows a Java client to access a remote Java object just like any other local Java object.

Before the application (238) processes the data contained in the messages (240), the application (238) receives the messages (240) from the messaging middleware (252), which, in turn, receives the application messages (240) from one of the feed adapter (208, 206) through the transport engine (256). The messaging middleware (252) is a software component that provides high availability services between the subscribing client device (210), the feed adapter (208), and the backup feed adapter (206). In addition, the messaging middleware (252) provides message administration services for the stream administration server (212). Such message administration services may include restricting the ability of the application (238) to send and receive messages on a message stream to messages that satisfy certain constraints. The application (238) and the stream administration library (272) interact with the messaging middleware (252) through a messaging middleware API (254).

The transport engine (256) of FIG. 2 is a software component operating in the transport and network layers of the OSI protocol stack promulgated by the International Organization for Standardization. The transport engine (256) provides data communications services between network-connected devices. The transport engine may be implemented according to the UDP/IP protocols, TCP/IP protocols, or any other data communications protocols as will occur to those of skill in the art. The transport engine (256) is a software component that includes a set of computer program instructions configured for receiving packets through the message stream (280, 282) from the feed adapters (208, 206), unencapsulating the application messages from the received packets, and providing the application messages to the messaging middleware (252). The messaging middleware (252) operates the transport engine (256) through a transport API (258) exposed by the transport engine (256).

In addition to the transport services mentioned above, the transport engine (256) of FIG. 2 also operates generally for reliable messaging using message streams in a high speed, low latency data communications environment according to embodiments of the present invention. The transport engine (256) of FIG. 2 operates for reliable messaging using message streams in a high speed, low latency data communications environment according to embodiments of the present invention by receiving, from an active message sending device, active transport packets on an active message stream (280) established from the active message sending device to the message receiving device; identifying a missing active application message from the active message sending device; and requesting, by the transport engine from a backup message sending device that becomes active upon failover from the active message sending device, transmission of a backup application message that corresponds to the missing active application message. The transport engine (256) of FIG. 2 also operates for reliable messaging using message streams in a high speed, low latency data communications environment according to embodiments of the present invention by receiving the backup mapping (203) from the backup message sending device; identifying, in dependence upon the backup mapping (203), a backup transport packet that includes the backup application message corresponding to the missing active application message; and requesting transmission of the identified backup transport packet.

The servers and other devices illustrated in the exemplary system of FIG. 2 are for explanation, not for limitation. Devices useful in reliable messaging using message streams in a high speed, low latency data communications environment may be implemented using general-purpose computers, such as, for example, computer servers or workstations, hand-held computer devices, such as, for example, Personal Digital Assistants (‘PDAs’) or mobile phones, or any other automated computing machinery configured for data processing according to embodiments of the present invention as will occur to those of skill in the art.

The arrangement of servers and other devices making up the exemplary system illustrated in FIG. 2 are for explanation, not for limitation. Although the connections to the network (200) of FIG. 2 are depicted and described in terms of wireline connections, readers will note that wireless connections may also be useful according to various embodiments of the present invention. Furthermore, data processing systems useful according to various embodiments of the present invention may include additional servers, routers, other devices, and peer-to-peer architectures, not shown in FIG. 2, as will occur to those of skill in the art. Networks in such data processing systems may support many data communications protocols, including for example Transmission Control Protocol (‘TCP’), Internet Protocol (‘IP’), HyperText Transfer Protocol (‘HTTP’), Wireless Access Protocol (‘WAP’), Handheld Device Transport Protocol (‘HDTP’), and others as will occur to those of skill in the art. Various embodiments of the present invention may be implemented on a variety of hardware platforms in addition to those illustrated in FIG. 2.

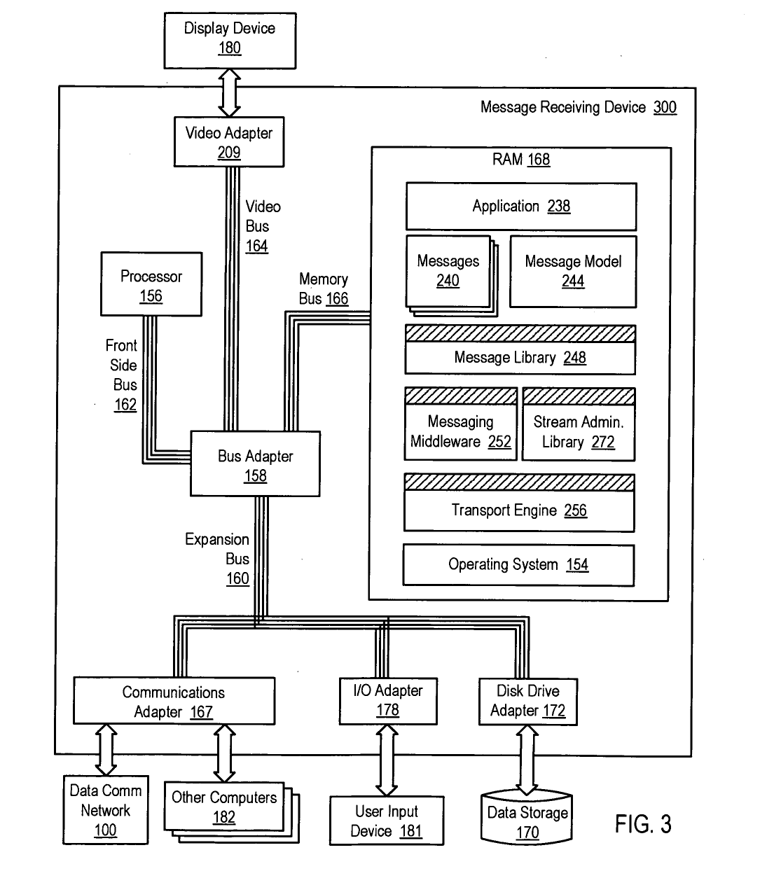

Providing reliable messaging using message streams in a high speed, low latency data communications environment in accordance with the present invention in some embodiments may be implemented with one or more message receiving devices, message sending devices, stream administration servers, that is, automated computing machinery. For further explanation, therefore, FIG. 3 sets forth a block diagram of automated computing machinery comprising an exemplary message receiving device (300), such as, for example, an exemplary subscribing client device, useful in providing reliable messaging using message streams in a high speed, low latency data communications environment according to embodiments of the present invention. The message receiving device (300) of FIG. 3 includes at least one computer processor (156) or ‘CPU’ as well as random access memory (168) (‘RAM’) which is connected through a high speed memory bus (166) and bus adapter (158) to processor (156) and to other components of the message receiving device.

Stored in RAM (168) is an application (238), application messages (240), message model (244), a message library (248), a messaging middleware (252) a stream administration library (272), and a transport engine (256). Each application message (240) is a quantity of data that includes one or more data fields and is transmitted from one device to another on a message stream. Application messages are typically created and processed by applications operating in application layers above the network and transport layers of a network protocol stack. As mentioned above, an application message may represent numeric or textual information, images, encrypted information, computer program instructions, and so on. In a financial market data environment, for example, a message is commonly referred to as a ‘tick’ and represents financial market data such as, for example, financial quotes or financial news. Each application message (240) may be implemented using a structured document such as, for example, an XML document, a Java object, C++ object, or any other implementation as will occur to those of skill in the art. The message model (244) is metadata that defines the structure and format of the messages (240). The message model (244) may also be implemented using a structured document such as, for example, an XML document, a Java object, C++ object, or any other implementation as will occur to those of skill in the art. The application (238), the message library (248), the messaging middleware (252), the stream administration library (272), and the transport engine (256) illustrated in FIG. 3 are software components, that is computer program instructions, that operate as described above with reference to FIG. 2 regarding the subscribing client device.

Also stored in RAM (168) is an operating system (154). Operating systems useful in message receiving devices according to embodiments of the present invention include UNIX™, Linux™, Microsoft NT™, IBM's AIX™, IBM's i5/OS™, and others as will occur to those of skill in the art. The operating system (154), the application (238), the messages (240), the message model (244), the message library (248), the messaging middleware (252), and the transport engine (256) in the example of FIG. 3 are shown in RAM (168), but many components of such software typically are stored in non-volatile memory also, for example, on a disk drive (170).

The exemplary message receiving device (300) of FIG. 3 includes bus adapter (158), a computer hardware component that contains drive electronics for high speed buses, the front side bus (162), the video bus (164), and the memory bus (166), as well as drive electronics for the slower expansion bus (160). Examples of bus adapters useful in message receiving devices useful according to embodiments of the present invention include the Intel Northbridge, the Intel Memory Controller Hub, the Intel Southbridge, and the Intel I/O Controller Hub. Examples of expansion buses useful in message receiving devices useful according to embodiments of the present invention may include Peripheral Component Interconnect (‘PCI’) buses and PCI Express (‘PCIe’) buses.

The exemplary message receiving device (300) of FIG. 3 also includes disk drive adapter (172) coupled through expansion bus (160) and bus adapter (158) to processor (156) and other components of the exemplary message receiving device (300). Disk drive adapter (172) connects non-volatile data storage to the exemplary message receiving device (300) in the form of disk drive (170). Disk drive adapters useful in message receiving devices include Integrated Drive Electronics (‘IDE’) adapters, Small Computer System Interface (‘SCSI’) adapters, and others as will occur to those of skill in the art. In addition, non-volatile computer memory may be implemented for a message receiving device as an optical disk drive, electrically erasable programmable read-only memory (so-called ‘EEPROM’ or ‘Flash’ memory), RAM drives, and so on, as will occur to those of skill in the art.

The exemplary message receiving device (300) of FIG. 3 includes one or more input/output (‘I/O’) adapters (178). I/O adapters in message receiving devices implement user-oriented input/output through, for example, software drivers and computer hardware for controlling output to display devices such as computer display screens, as well as user input from user input devices (181) such as keyboards and mice. The exemplary message receiving device (300) of FIG. 3 includes a video adapter (209), which is an example of an I/O adapter specially designed for graphic output to a display device (180) such as a display screen or computer monitor. Video adapter (209) is connected to processor (156) through a high speed video bus (164), bus adapter (158), and the front side bus (162), which is also a high speed bus.

The exemplary message receiving device (300) of FIG. 3 includes a communications adapter (167) for data communications with other computers (182) and for data communications with a high speed, low latency data communications network (200). Such data communications may be carried out serially through RS-232 connections, through external buses such as a Universal Serial Bus (‘USB’), through data communications networks such as IP data communications networks, and in other ways as will occur to those of skill in the art. Communications adapters implement the hardware level of data communications through which one computer sends data communications to another computer, directly or through a data communications network. Examples of communications adapters useful for providing reliable messaging using message streams in a high speed, low latency data communications environment according to embodiments of the present invention wired data communications network communications, and IEEE 802.11b adapters for wireless data communications network communications.

Although FIG. 3 is discussed with reference to exemplary message receiving devices, readers will note that automated computing machinery comprising exemplary message sending devices, such as, for example, feed adapters, and exemplary stream administration servers useful in providing reliable messaging using message streams in a high speed, low latency data communications environment according to embodiments of the present invention are similar to the exemplary message receiving device (300) of FIG. 3. That is, such exemplary stream administration servers and feed adapters include one or more processors, bus adapters, buses, RAM, video adapters, communications adapters, I/O adapters, disk drive adapters, and other components similar to the exemplary message receiving device (300) of FIG. 3 as will occur to those of skill in the art.

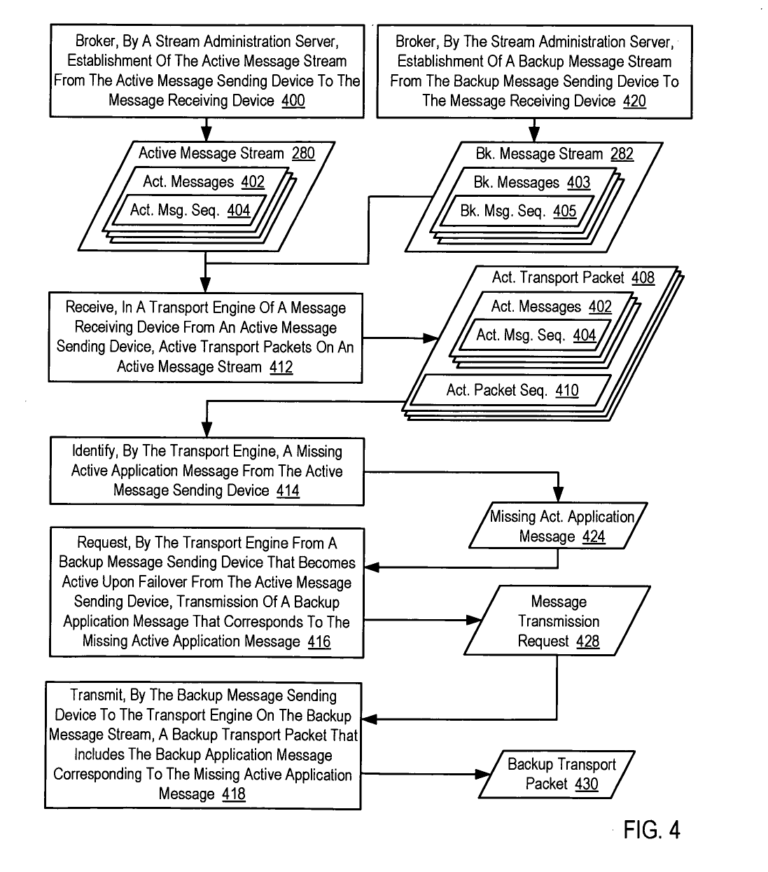

For further explanation, FIG. 4 sets forth a flowchart illustrating an exemplary method for reliable messaging using message streams in a high speed, low latency data communications environment according to embodiments of the present invention. The method of FIG. 4 includes brokering (400), by a stream administration server, establishment of the active message stream (280) from an active message sending device to a message receiving device. The active message stream (280) represents a data communication channel between a communications endpoint of a message receiving device and a communications endpoint of a message sending device. A message stream may be implemented as a multicast data communication channel using the UDP/IP protocols or a unicast data communication channel using TCP/IP protocols as discussed above with reference to FIG. 2.

In the example of FIG. 4, the active message stream (280) includes active application messages (402). The active application messages (402) represent application messages received by a message receiving device from an active message sending device. Each active application message (402) in the example of FIG. 4 is characterized by an active message sequence number (404). The active message sequence number (404) uniquely identifies an active application message among other application messages transmitted from a particular active message sending device. The active message sequence number (404) also provides the relative transmission order for a particular active application message with respect to the other active application messages transmitted from the active message sending device.

In the method of FIG. 4, brokering (400), by a stream administration server, establishment of the active message stream (280) from an active message sending device to a message receiving device may be carried out by receiving a subscription request from a message receiving device to subscribe to messages from a message sending device. The subscription request may be implemented as an XML document, a call to a member method of a RMI object on the message receiving device, or any other implementation as will occur to those of skill in the art. The subscription request may include topics of the messages that the message receiving device requests to receive from the message sending device. A topic represents the characteristics of the messages that the message receiving device requests. Using a topic, a message receiving device may specify the group of messages for receipt from the message sending device. In a financial market data environment, for example, a message receiving device may use a topic to request ticks from an OPRA feed source that contains quotes of an IBM option traded on the Chicago Board Options Exchange (‘CBOE’) that includes the best bid and best ask for the IBM option on the CBOE.

Brokering (400), by a stream administration server, establishment of the active message stream (280) from an active message sending device to a message receiving device according to the method of FIG. 4 may also include providing the message receiving device a destination address for the message sending device. The destination address for the message sending device is a multicast address or a unicast address used by the message receiving device to listen for messages from a message sending device. Using the destination address provided by the stream administration server, the message receiving device may establish the active message stream (280) from the message sending device to the message receiving device.

Before the stream administration server provides the destination address for the message sending device, the stream administration server in the example of FIG. 4 may perform several security services to ensure that the message receiving device only receives messages from the message sending device for which the message receiving device is authorized to receive. In the method of FIG. 4, brokering (400), by a stream administration server, establishment of the active message stream (280) from an active message sending device to a message receiving device may also be carried out by authenticating the message receiving device and authorizing the message receiving device to receive messages from the message sending device on the message stream (280). Authenticating the message receiving device may be carried out by verifying client security credentials provided by the message receiving device with the subscription request. The client security credentials may be implemented as a digital signature in a public key infrastructure, a security token, or any other security data as will occur to those of skill in the art for authenticating the identity of the originator of the subscription request. Authorizing the message receiving device to receive messages from the message sending device on the message stream (280) may be carried out by identifying the privileges associated with the authenticated message receiving device in dependence upon an authorization policy. An authorization policy is a set of rules governing the privileges of authenticated message receiving devices requesting to receive data from a message sending device.

The method of FIG. 4 also includes brokering (420), by the stream administration server, establishment of a backup message stream (282) from the backup message sending device to the message receiving device. In the method of FIG. 4, brokering (420), by the stream administration server, establishment of a backup message stream (282) from the backup message sending device to the message receiving device may be carried out in a manner similar to brokering (400), by a stream administration server, establishment of the active message stream (280) from an active message sending device to a message receiving device.

The backup message stream (282) of FIG. 4 represents a data communication channel between a communications endpoint of a message receiving device and a communications endpoint of a message sending device. In the example of FIG. 4, the backup message stream (282) includes backup application messages (403). Each backup application message (403) represents a duplicate of a corresponding active application message (402). The backup application messages (403) represent application messages received by a message receiving device from a backup message sending device. Each backup application message (403) of FIG. 4 is characterized by a backup message sequence number (405) that uniquely identifies the backup application message among other application messages transmitted from a particular backup message sending device. A backup message sequence number also provides the relative transmission order for a particular backup application message with respect to the other backup application messages transmitted from the backup message sending device.

The method of FIG. 4 also includes receiving (412), in a transport engine of a message receiving device from an active message sending device, active transport packets (402) on an active message stream (280) established from the active message sending device to the message receiving device. The active message sending device encapsulates the active application messages (402) in the active transport packets (408). Each active transport packet (408) represents a quantity of data transmitted as a whole from one device to another on a network. Examples of transport packets may include TCP packets or UDP datagrams. Each active transport packet (408) of FIG. 4 includes one or more active application messages (402). As mentioned above, readers will note that in this specification a transport packet that includes one application message may refer to a transport packet that includes an entire application message or a fragment of an application message. Each active transport packet (408) of FIG. 4 is characterized by an active packet sequence number (410). The active packet sequence number (410) uniquely identifies an active transport packet among other active transport packets transmitted from a particular active message sending device. The active packet sequence number (410) also provides the relative transmission order for a particular active transport with respect to the other active transport packets transmitted from the active message sending device.

The method of FIG. 4 also includes identifying (414), by the transport engine, a missing active application message (424) from the active message sending device. The missing active application message (424) represents an active application message (402) not received by the message receiving device, typically, because the message receiving device did not receive the active transport packet containing the missing active application message (424). Identifying (414), by the transport engine, a missing active application message (424) from the active message sending device according to the method of FIG. 2 may be carried out by counting down from a predetermined timeout period when an active application message is received in the transport engine of the message receiving device that has a value for the active message sequence number (404) that is higher than the previous highest value by at least two. Identifying (414), by the transport engine, a missing active application message (424) from the active message sending device according to the method of FIG. 4 may further be carried out by identifying, as the missing active application message (424) after the predetermined timeout period, any active application message having a value for its active message sequence number that is between the values for the active message sequence number of the active application message having the previous highest value for an active message sequence number and the active application message having a value for an active message sequence number that is higher than the previous highest value by at least two.

The method of FIG. 4 also includes requesting (416), by the transport engine from a backup message sending device that becomes active upon failover from the active message sending device, transmission of a backup application message that corresponds to the missing active application message (424). Similar to the active message sending device, the backup message sending device encapsulates backup application messages in backup transport packets for transmission on the backup message stream (282) established from the backup message sending device to the message receiving device. Each backup transport packet includes one or more backup application messages (403) and is characterized by a backup packet sequence number. The backup message sending device provides a redundant source of application messages for the message receiving device in the event of a failover from the active message sending device to the backup message sending device. In accordance with the present invention, the backup message sending device also provides a redundant source of application messages for the message receiving device before any failover occurs.

Requesting (416), by the transport engine from a backup message sending device, transmission of a backup application message that corresponds to the missing active application message (424) according to the method of FIG. 4 may be carried out by transmitting, from the transport engine to the backup message sending device, a message transmission request (428) for the backup application message that corresponds to the missing active application message (424). The message transmission request (428) represents a negative acknowledgement (‘NAK’) indicating that the message receiving device did not receive a particular missing active application message (424). The message transmission request (428) of FIG. 4 may specify the backup application message that corresponds to the missing active application message (424) using the backup message sequence number of the backup application message that corresponds to the missing active application message (424).

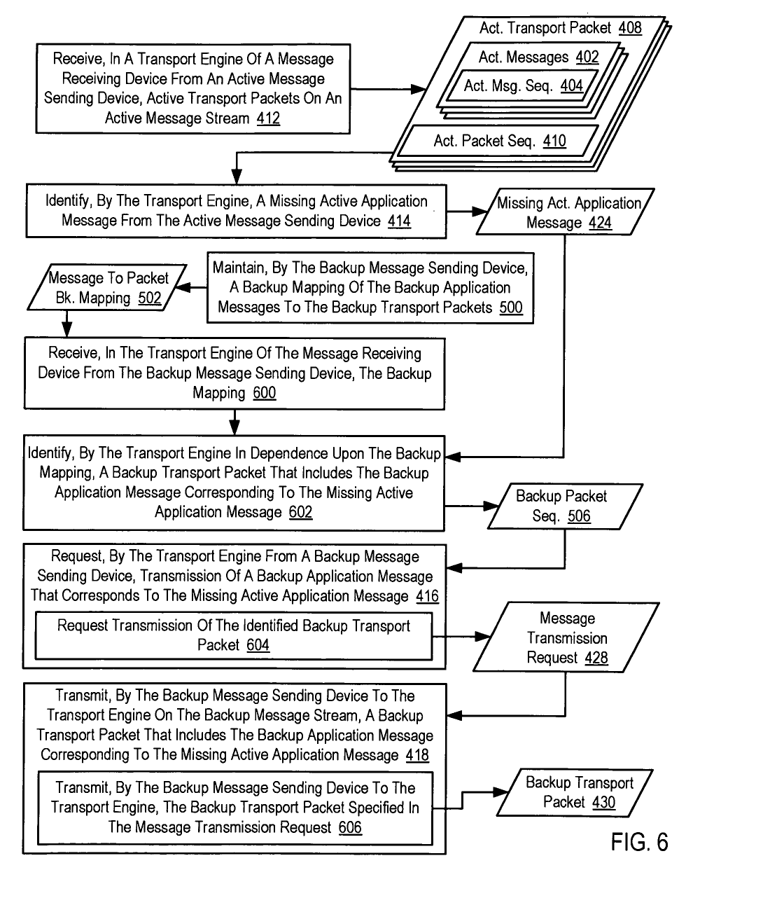

The message transmission request (428) of FIG. 4 may also specify the backup application message that corresponds to the missing active application message (424) using the backup packet sequence number of the backup transport packet that contains the backup application message that corresponds to the missing active application message (424). Requesting (416), by the transport engine from a backup message sending device, transmission of a backup application message that corresponds to the missing active application message (424) according to the method of FIG. 4, therefore, may also be carried out by requesting transmission of a backup transport packet that includes the backup application message as discussed below with reference to FIG. 6.

The method of FIG. 4 includes transmitting (418), by the backup message sending device to the transport engine on the backup message stream (282), a backup transport packet (430) that includes the backup application message corresponding to the missing active application message (424). Transmitting (418), by the backup message sending device to the transport engine on the backup message stream (282), a backup transport packet (430) that includes the backup application message corresponding to the missing active application message (424) according to the method of FIG. 4 may be carried out using a message stream implemented according to the UDP/IP protocols or TCP/IP protocols.

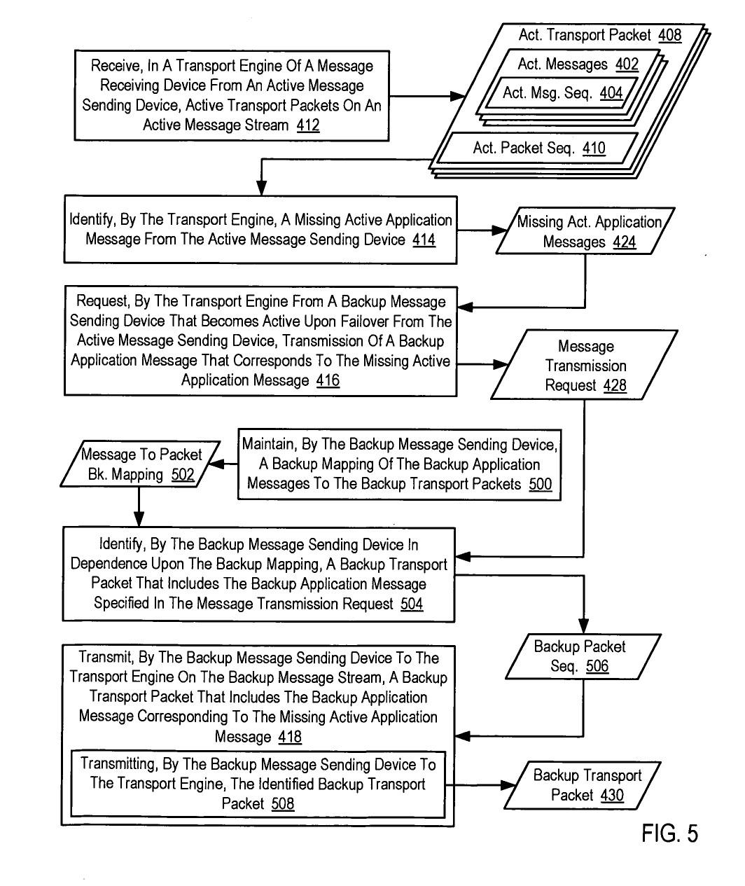

When a message sending device requests transmission of a backup application message that corresponds to the missing active application message using a message transmission request that specifies the backup application message using the backup message sequence number, the backup message sending device identifies a backup transport packet that includes the backup application message specified in the message transmission request and transmits the backup transport packet to the message receiving device. For further explanation, therefore, FIG. 5 sets forth a flowchart illustrating a further exemplary method for reliable messaging using message streams in a high speed, low latency data communications environment according to embodiments of the present invention that includes identifying (504), by the backup message sending device in dependence upon a backup mapping (502), a backup transport packet that includes the backup application message specified in the message transmission request (428).

The method of FIG. 5 is similar to the method of FIG. 4 in that the method of FIG. 5 includes: receiving (412), in a transport engine of a message receiving device from an active message sending device, active transport packets (402) on an active message stream (280) established from the active message sending device to the message receiving device; identifying (414), by the transport engine, a missing active application message (424) from the active message sending device; requesting (416), by the transport engine from a backup message sending device that becomes active upon failover from the active message sending device, transmission of a backup application message that corresponds to the missing active application message(424); and transmitting (418), by the backup message sending device to the transport engine on the backup message stream, a backup transport packet (430) that includes the backup application message corresponding to the missing active application message (424).

Similar to the example of FIG. 4, the active message sending device in the example of FIG. 5 encapsulates active application messages (402) in the active transport packets (408) and each active transport packet (408) includes one or more active application messages (402). Each active transport packet (408) is characterized by an active packet sequence number (410), and each active application message (402) is characterized by an active message sequence number (404). The backup message sending device encapsulates backup application messages in backup transport packets for transmission on a backup message stream established from the backup message sending device to the message receiving device. Each backup transport packet includes one or more backup application messages. Each backup application message represents a duplicate of a corresponding active application message (402). Each backup transport packet is characterized by a backup packet sequence number, and each backup application message is characterized by a backup message sequence number.

The method of FIG. 5 includes maintaining (500), by the backup message sending device, a backup mapping (502) of the backup application messages to the backup transport packets. The backup mapping (502) of the backup application messages to the backup transport packets is a map of the particular backup application messages that the backup message sending device encapsulated into each backup transport packet. For example, the backup mapping (502) may indicate that backup transport packet one includes backup application messages one, two, and three, and that backup transport packet two includes backup application message four. Maintaining (500), by the backup message sending device, a backup mapping (502) of the backup application messages to the backup transport packets according to the method of FIG. 5 may be carried out by associating in a table the value for the backup packet sequence number of a backup transport packet with the values for the backup message sequence number of the backup application messages encapsulated in the particular backup transport packet.

The method of FIG. 5 also includes identifying (504), by the backup message sending device in dependence upon the backup mapping (502), a backup transport packet (430) that includes the backup application message specified in the message transmission request (428). Identifying (504) a backup transport packet (430) that includes the backup application message specified in the message transmission request (428) according to the method of FIG. 5 may be carried out by retrieving the value for the backup packet sequence number (506) of the backup transport packet that encapsulates the backup application message having the backup message sequence number specified in the message transmission request (428).

In the method of FIG. 5, transmitting (418), by the backup message sending device to the transport engine on the backup message stream, a backup transport packet (430) that includes the backup application message corresponding to the missing active application message (424) includes transmitting (508), by the backup message sending device to the transport engine, the identified backup transport packet (430). Transmitting (508), by the backup message sending device to the transport engine, the identified backup transport packet (430) according to the method of FIG. 5 may be carried out by transmitting the backup transport packet (430) having a value for the backup packet sequence number that matches the value for the backup packet sequence number (506). Transmitting the backup transport packet (430) having a value for the backup packet sequence number that matches the value for the backup packet sequence number (506) may be carried out using a message stream implemented according to the UDP/IP protocols or TCP/IP protocols.

When a message sending device requests transmission of a backup application message that corresponds to the missing active application message using a message transmission request that specifies the backup transport packet that contains the backup application message using the backup packet sequence number, the message receiving device identifies a backup transport packet that includes the backup application message corresponding to the missing active application message. For further explanation, therefore, FIG. 6 sets forth a flowchart illustrating a further exemplary method for reliable messaging using message streams in a high speed, low latency data communications environment according to embodiments of the present invention that includes identifying (602), by the transport engine in dependence upon the backup mapping (502), a backup transport packet (430) that includes the backup application message corresponding to the missing active application message (424).

The method of FIG. 6 is similar to the methods of FIGS. 4 and 5 in that the method of FIG. 6 includes: receiving (412), in a transport engine of a message receiving device from an active message sending device, active transport packets (402) on an active message stream (280) established from the active message sending device to the message receiving device; identifying (414), by the transport engine, a missing active application message (424) from the active message sending device; maintaining (500), by the backup message sending device, a backup mapping (502) of the backup application messages to the backup transport packets; requesting (416), by the transport engine from a backup message sending device that becomes active upon failover from the active message sending device, transmission of a backup application message that corresponds to the missing active application message (424); and transmitting (418), by the backup message sending device to the transport engine on the backup message stream, a backup transport packet (430) that includes the backup application message corresponding to the missing active application message (424).

Similar to the examples of FIGS. 4 and 5, the active message sending device in the example of FIG. 6 encapsulates active application messages (402) in the active transport packets (408) and each active transport packet (408) includes one or more active application messages (402). Each active transport packet (408) is characterized by an active packet sequence number (410), and each active application message (402) is characterized by an active message sequence number (404). The backup message sending device encapsulates backup application messages in backup transport packets for transmission on a backup message stream established from the backup message sending device to the message receiving device. Each backup transport packet includes one or more backup application messages. Each backup application message represents a duplicate of a corresponding active application message (402). Each backup transport packet is characterized by a backup packet sequence number, and each backup application message is characterized by a backup message sequence number.

The method of FIG. 6 includes receiving (600), in the transport engine of the message receiving device from the backup message sending device, the backup mapping (502). Receiving (600), in the transport engine of the message receiving device from the backup message sending device, the backup mapping (502) according to the method of FIG. 6 may be carried out by receiving a backup transport packet containing the backup mapping (502) of the backup application messages to the backup transport packets. The backup transport packet containing the backup mapping (502) of FIG. 6 may be an administrative transport packet transmitted on a backup message stream from a transport engine of the backup message sending device to the transport engine of the message receiving device. Unlike transport packets that include one or more of the application messages, a transport packet containing the backup mapping (502) is typically not passed along to application software components that reside above the transport layer of the network protocol stack because the transport packet containing the backup mapping (502) is an administrative packet between transport engines that reside in the transport layer of the network protocol stack. The transport engine of the message receiving device may differentiate the transport packet that contains the backup mapping (502) from the transport packets that include one or more of the application messages by identifying the packet type for each transport packet received using a packet header field. An example of an administrative packet that may be improved for reliable messaging using message streams in a high speed, low latency data communications environment according to embodiments of the present invention includes a Source Path Message (‘SPM’) of the Pragmatic General Multicast (‘PGM’) Protocol.

The method of FIG. 6 also includes identifying (602), by the transport engine in dependence upon the backup mapping (502), a backup transport packet (430) that includes the backup application message corresponding to the missing active application message (424). Identifying (602), by the transport engine in dependence upon the backup mapping (502), a backup transport packet that includes the backup application message corresponding to the missing active application message (424) according to the method of FIG. 6 may be carried out by retrieving the value for the backup packet sequence number (506) of the backup transport packet (430) that encapsulates the backup application message having the backup message sequence number matching the active message sequence number of the missing active application message (424).

In the method of FIG. 6, requesting (416), by the transport engine from a backup message sending device that becomes active upon failover from the active message sending device, transmission of a backup application message that corresponds to the missing active application message (424) includes requesting (604) transmission of the identified backup transport packet. Requesting (604) transmission of the identified backup transport packet according to the method of FIG. 6 may be carried out by transmitting, from the transport engine to the backup message sending device, a message transmission request (428) for the backup transport packet (430) that includes the backup application message corresponding to the missing active application message (424). The message transmission request (428) of FIG. 6 specifies the backup transport packet that includes the backup application message corresponding to the missing active application message (424) using the backup packet sequence number (506) of the backup transport packet (430) that contains the backup application message that corresponds to the missing active application message (424).

In the method of FIG. 6, transmitting (418), by the backup message sending device to the transport engine on the backup message stream, a backup transport packet (430) that includes the backup application message corresponding to the missing active application message (424) includes transmitting (606), by the backup message sending device to the transport engine, the backup transport packet (430) specified in the message transmission request (428). Transmitting (606), by the backup message sending device to the transport engine, the backup transport packet (430) specified in the message transmission request (428) according to the method of FIG. 6 may be carried out by transmitting the backup transport packet (430) having a value for the backup packet sequence number that matches the value for the backup packet sequence number (506). Transmitting the backup transport packet (430) having a value for the backup packet sequence number that matches the value for the backup packet sequence number (506) may be carried out using a message stream implemented according to the UDP/IP protocols or TCP/IP protocols.

In view of the explanations set forth above in this document, readers will recognize that practicing reliable messaging using message streams in a high speed, low latency data communications environment according to embodiments of the present invention provides the following benefits:
the ability in the transport layer of a network protocol stack to request retransmission of application messages recognized by application software operating in the application layer,
the ability of a message receiving device to request from a backup message sending device the specific application messages not received from an active message sending device even though no failover has occurred from the active message sending device to the backup message sending device, and
the ability of a message receiving device to request from a backup message sending device the specific transport packets in which the backup message sending device encapsulated application messages not received from an active message sending device even though no failover has occurred from the active message sending device to the backup message sending device.

Exemplary embodiments of the present invention are described largely in the context of a fully functional computer system for reliable messaging using message streams in a high speed, low latency data communications environment. Readers of skill in the art will recognize, however, that the present invention also may be embodied in a computer program product disposed on signal bearing media for use with any suitable data processing system. Such signal bearing media may be a transmission media or a recordable media for machine-readable information, including magnetic media, optical media, or other suitable media. Examples of recordable media include magnetic disks in hard drives or diskettes, compact disks for optical drives, magnetic tape, and others as will occur to those of skill in the art. Examples of transmission media include telephone networks for voice communications and digital data communications networks such as, for example, Ethernets™ and networks that communicate with the Internet Protocol and the World Wide Web as well as wireless transmission media such as, for example, networks implemented according to the IEEE 802.11 family of specifications. Persons skilled in the art will immediately recognize that any computer system having suitable programming means will be capable of executing the steps of the method of the invention as embodied in a program product. Persons skilled in the art will recognize immediately that, although some of the exemplary embodiments described in this specification are oriented to software installed and executing on computer hardware, nevertheless, alternative embodiments implemented as firmware or as hardware are well within the scope of the present invention.

It will be understood from the foregoing description that modifications and changes may be made in various embodiments of the present invention without departing from its true spirit. The descriptions in this specification are for purposes of illustration only and are not to be construed in a limiting sense. The scope of the present invention is limited only by the language of the following claims.

What is claimed is:

1. A method of reliable messaging using message streams in a high speed, low latency data communications environment, the method comprising:
receiving, in a transport engine of a message receiving device from an active message sending device, active transport packets on an active message stream established from the active message sending device to the message receiving device, the active message sending device encapsulating active application messages in the active transport packets, each active transport packet including one or more active application messages;
identifying, by the transport engine, a missing active application message from the active message sending device; and
requesting, by the transport engine from a backup message sending device that becomes active upon failover from the active message sending device, transmission of a backup application message that corresponds to the missing active application message, the backup message sending device encapsulating backup application messages in backup transport packets for transmission on a backup message stream established from the backup message sending device to the message receiving device, each backup transport packet including one or more backup application messages, each backup application message representing a duplicate of a corresponding active application message.

2. The method of claim 1 further comprising:
transmitting, by the backup message sending device to the transport engine on the backup message stream, a backup transport packet that includes the backup application message corresponding to the missing active application message.

3. The method of claim 2 further comprising:
maintaining, by the backup message sending device, a backup mapping of the backup application messages to the backup transport packets; and
identifying, by the backup message sending device in dependence upon the backup mapping, a backup transport packet that includes the backup application message specified in the message transmission request,
wherein transmitting, by the backup message sending device to the transport engine, a backup transport packet that includes the backup application message corresponding to the missing active application message further comprises transmitting, by the backup message sending device to the transport engine, the identified backup transport packet.

4. The method of claim 2 further comprising:
maintaining, by the backup message sending device, a backup mapping of the backup application messages to the backup transport packets;
receiving, in the transport engine of the message receiving device from the backup message sending device, the backup mapping; and
identifying, by the transport engine in dependence upon the backup mapping, a backup transport packet that includes the backup application message corresponding to the missing active application message,
wherein requesting, by the transport engine from a backup message sending device, transmission of a backup application message that corresponds to the missing active application message further comprises requesting transmission of the identified backup transport packet, and
wherein transmitting, by the backup message sending device to the transport engine, a backup transport packet that includes the backup application message corresponding to the missing active application message further comprises transmitting, by the backup message sending device to the transport engine, the backup transport packet specified in the message transmission request.

5. The method of claim 1 further comprising:
brokering, by a stream administration server, establishment of the active message stream from the active message sending device to the message receiving device; and
brokering, by the stream administration server, establishment of a backup message stream from the backup message sending device to the message receiving device.

6. The method of claim 1 wherein:
the message receiving device is a subscribing client device;
the active message sending device is an active feed adapter; and
the backup message sending device is a backup feed adapter.

7. The method of claim 6 wherein each feed adapter comprises a device having the capabilities of converting messages on a feed adapter input stream having a first format to messages on a feed adapter output stream having a second format and transmitting the messages on the feed adapter output stream to subscribing client devices.

8. The method of claim 1 wherein:
each active transport packet is characterized by an active packet sequence number;
each active application message is characterized by an active message sequence number;
each backup transport packet is characterized by a backup packet sequence number; and
each backup application message is characterized by a backup message sequence number.

9. An apparatus for reliable messaging using message streams in a high speed, low latency data communications environment, the apparatus comprising a computer processor, a computer memory operatively coupled to the computer processor, the computer memory having disposed within it computer program instructions capable of:
receiving, in a transport engine of a message receiving device from an active message sending device, active transport packets on an active message stream established from the active message sending device to the message receiving device, the active message sending device encapsulating active application messages in the active transport packets, each active transport packet including one or more active application messages;
identifying, by the transport engine, a missing active application message from the active message sending device; and
requesting, by the transport engine from a backup message sending device that becomes active upon failover from the active message sending device, transmission of a backup application message that corresponds to the missing active application message, the backup message sending device encapsulating backup application messages in backup transport packets for transmission on a backup message stream established from the backup message sending device to the message receiving device, each backup transport packet including one or more backup application messages, each backup application message representing a duplicate of a corresponding active application message.

10. The apparatus of claim 9 further comprising computer program instructions capable of:
transmitting, by the backup message sending device to the transport engine on the backup message stream, a backup transport packet that includes the backup application message corresponding to the missing active application message.

11. The apparatus of claim 10 further comprising computer program instructions capable of:
maintaining, by the backup message sending device, a backup mapping of the backup application messages to the backup transport packets; and
identifying, by the backup message sending device in dependence upon the backup mapping, a backup transport packet that includes the backup application message specified in the message transmission request,
wherein transmitting, by the backup message sending device to the transport engine, a backup transport packet that includes the backup application message corresponding to the missing active application message further comprises transmitting, by the backup message sending device to the transport engine, the identified backup transport packet.

12. The apparatus of claim 10 further comprising computer program instructions capable of:
maintaining, by the backup message sending device, a backup mapping of the backup application messages to the backup transport packets;
receiving, in the transport engine of the message receiving device from the backup message sending device, the backup mapping; and
identifying, by the transport engine in dependence upon the backup mapping, a backup transport packet that includes the backup application message corresponding to the missing active application message,
wherein requesting, by the transport engine from a backup message sending device, transmission of a backup application message that corresponds to the missing active application message further comprises requesting transmission of the identified backup transport packet, and
wherein transmitting, by the backup message sending device to the transport engine, a backup transport packet that includes the backup application message corresponding to the missing active application message further comprises transmitting, by the backup message sending device to the transport engine, the backup transport packet specified in the message transmission request.

13. The apparatus of claim 9 further comprising computer program instructions capable of:
brokering, by a stream administration server, establishment of the active message stream from the active message sending device to the message receiving device; and
brokering, by the stream administration server, establishment of a backup message stream from the backup message sending device to the message receiving device.

14. A computer program product for reliable messaging using message streams in a high speed, low latency data communications environment, the computer program product disposed upon a signal bearing medium, the computer program product comprising computer program instructions capable of:
receiving, in a transport engine of a message receiving device from an active message sending device, active transport packets on an active message stream established from the active message sending device to the message receiving device, the active message sending device encapsulating active application messages in the active transport packets, each active transport packet including one or more active application messages;
identifying, by the transport engine, a missing active application message from the active message sending device; and
requesting, by the transport engine from a backup message sending device that becomes active upon failover from the active message sending device, transmission of a backup application message that corresponds to the missing active application message, the backup message sending device encapsulating backup application messages in backup transport packets for transmission on a backup message stream established from the backup message sending device to the message receiving device, each backup transport packet including one or more backup application messages, each backup application message representing a duplicate of a corresponding active application message.

15. The computer program product of claim 14 wherein the signal bearing medium comprises a recordable medium.

16. The computer program product of claim 14 wherein the signal bearing medium comprises a transmission medium.

17. The computer program product of claim 14 further comprising computer program instructions capable of:
transmitting, by the backup message sending device to the transport engine on the backup message stream, a backup transport packet that includes the backup application message corresponding to the missing active application message.

18. The computer program product of claim 17 further comprising computer program instructions capable of:
maintaining, by the backup message sending device, a backup mapping of the backup application messages to the backup transport packets; and
identifying, by the backup message sending device in dependence upon the backup mapping, a backup transport packet that includes the backup application message specified in the message transmission request,
wherein transmitting, by the backup message sending device to the transport engine, a backup transport packet that includes the backup application message corresponding to the missing active application message further comprises transmitting, by the backup message sending device to the transport engine, the identified backup transport packet.

19. The computer program product of claim 17 further comprising computer program instructions capable of:
maintaining, by the backup message sending device, a backup mapping of the backup application messages to the backup transport packets;
receiving, in the transport engine of the message receiving device from the backup message sending device, the backup mapping; and
identifying, by the transport engine in dependence upon the backup mapping, a backup transport packet that includes the backup application message corresponding to the missing active application message,
wherein requesting, by the transport engine from a backup message sending device, transmission of a backup application message that corresponds to the missing active application message further comprises requesting transmission of the identified backup transport packet, and
wherein transmitting, by the backup message sending device to the transport engine, a backup transport packet that includes the backup application message corresponding to the missing active application message further comprises transmitting, by the backup message sending device to the transport engine, the backup transport packet specified in the message transmission request.

20. The computer program product of claim 14 further comprising computer program instructions capable of:
brokering, by a stream administration server, establishment of the active message stream from the active message sending device to the message receiving device; and
brokering, by the stream administration server, establishment of a backup message stream from the backup message sending device to the message receiving device.
